(19) United States
(12) Patent Application Publication
(10) Pub. No.: US 2010/0332293 A1
(43) Pub. Date: Dec. 30, 2010

(54) COMPLIANCE MANAGEMENT SYSTEM

(76) Inventor: Neil MERCHANT, Calgary (CA)

Correspondence Address: SHERIDAN ROSS PC, 1560 BROADWAY, SUITE 1200, DENVER, CO, 80202, US

(21) Appl. No.: 12/822,667

(22) Filed: Jun. 24, 2010

Related U.S. Application Data
(60) Provisional application No. 61/219,915, filed on Jun. 24, 2009.

(51) Int. Cl. G06Q 10/00; G01S 19/39

(52) U.S. Cl. 705/11; 705/7

(57) ABSTRACT

A system is provided for central monitoring of operational and safety compliance at remote work sites.

### CROSS-REFERENCE TO RELATED APPLICATIONS

This application is a non-provisional application claiming priority from the provisional application Ser. No. 61/219,915, entitled “Compliance Management System”, filed on Jun. 24, 2009, said provisional application being incorporated herein by reference in its entirety.

### FIELD OF THE INVENTION

The present invention relates generally to the monitoring of remote projects from a centralized location. More specifically, a system is provided for the collection, review, and reporting of remote site compliance with predetermined project parameters.

### BACKGROUND OF THE INVENTION

When managing multi-site projects, resource sharing between sites is often complicated. Some expertise and data may be communicated verbally and/or electronically, while equipment and personnel are often shared physically by transport between sites. However, various project sites may have varying scopes of work, safety requirements, access, and security. This creates problems in sharing resources.

For example, highly trained safety personnel may be required at certain sites to deal with urgent situations, however these sites may not be in close proximity to one another. Accordingly, while full-time access to a specific expert may be required to deal with urgent situations, having such a person on-site full-time may lead to underutilization of this expertise.

Conversely, on-site project managers/engineers are familiar with their own site operations and objectives, but may be unfamiliar with highly specialized aspects of the operation. Thus, at work sites without full-time, on-site specialists, the project manager must be able to recognize when input from a specialist is required, and must liase with such specialists as necessary. Unfortunately, this often leads to further redundancy in communications and documentation. Further, the project manager may fail to recognize when specialist input is needed, leading to negative performance outcomes or potentially hazardous site conditions. The lack of communication and documentation inherently contributing to the negative outcome or condition may prevent proper recognition of the problem, and therefore appropriate corrective action may not be taken. Still further, any legislated or otherwise regulated documentation requirements may be compromised by these oversights, leading to liability concerns.

In addition to the above-noted documentation issues, employers are typically unable to adequately monitor site conditions, work progress, contractor/personnel performance, and timely compliance with project parameters (particularly health and safety obligations) until after the work has been completed. Without sufficient documentation, even such post-project review may be futile, and certainly would not be able to correct any deficiencies or non-compliance issues.

### SUMMARY OF THE INVENTION

It is an object of the present invention to obviate or mitigate at least one disadvantage of previous remote site management systems.

In a first aspect, the present invention provides a system for monitoring operational compliance at multiple work sites from a central monitoring site, the system comprising: a planning module for setting operational guidelines for first and second work sites; a documentation module for daily recordal of operational data at said first and second work sites; and a monitoring module for receiving recorded data from each work site, comparing said data to the respective operational guidelines, and initiating corrective action in respect of any variance between the received data and the operational guidelines.

In one embodiment, the operational data is recorded electronically, and the monitoring module comprises a processor programmed to compare the recorded data from each work site to the operational guidelines.

In another embodiment, the corrective action comprises revising one or more operational guidelines.

In another embodiment, the corrective action comprises setting additional operational guidelines.

In accordance with a second aspect of the invention, there is provided a system for use in monitoring activity at two or more remote sites, the system comprising:
a data input device at a first project site, the input device for use in entering operational data documenting activities at the first project site;
a data input device at a second project site, the input device for use in entering operational data documenting activities at the second project site; and
a central monitoring location comprising a processor in communication with the input devices, the processor comprising a set of project site operational guidelines for use in assessing compliance of the activities at the first and second project sites.

In an embodiment, the processor compares the operational data to the operational guidelines to determine the presence of a variance event. The system may further comprise an alert module for initiating an alert at the central monitoring location, first project site, or second project site when a variance event is detected.

In various embodiments, the operational data comprises: GPS validation data of project resources; equipment maintenance data; training verification data; certification data; personnel or contractor performance data; surveillance data; daily work plan verification data; site access data; guideline variance data; safety compliance data; incident report data; regulatory compliance data; attendance data; inspection data; and/or safety status data.

In accordance with another aspect of the invention, there is provided a system for monitoring operational compliance at multiple work sites from a monitoring site, the system comprising:
a first set of operational guidelines associated with a first remote work site;
a first operator located at the first remote work site for supervising and documenting operations at the first work site in accordance with the first set of operational guidelines;
a second set of operational guidelines associates with a second remote work site;
a second operator located at the second remote work site for supervising and documenting operations at the second work site in accordance with the second set of operational guidelines;
a compliance management module in communication with the first and second operators for receiving and reviewing documents of daily operations from the first and second operators, comparing said documents to the first and second operational guidelines, and initiating communication with the first and second operators regarding the correction of any variance between the documents and the operational guidelines.

In one embodiment, the compliance management module accesses relevant standards and/or regulations and updates the first and second operational guidelines accordingly.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of a project flowchart;

FIG. 2 is a schematic of a project flowchart with monitoring and intervention modules;

FIG. 3 is a schematic depicting the flow of monitoring information;

FIG. 4 is a schematic depicting communication between an on-site supervisor and the Control Centre;

FIG. 5 is a chart identifying a sample project outline;

FIG. 6 is a sample First Aid Assessment Worksheet; and

FIG. 7 is a sample Road Safety Assessment Checklist.

### DETAILED DESCRIPTION

Generally, the present invention provides a method and system for monitoring and improving compliance in multi-site project management situations. The system is particularly suitable for monitoring and documenting compliance with safety and regulatory procedures. The system provides for the transformation of on-site occurrences into a documented, monitored compliance validation system, and in some circumstances, the transformation of a non-compliant project site or situation into a compliant project site or situation. The methods described are used in the transformation of data and site conditions to improve compliance with project parameters or regulations.

Specifically, the system provides centralized safety and regulatory monitoring and management of various remote work sites. Information may be gathered and monitored using software and other computer-assisted technologies.

Typically, a central site will monitor two or more remote sites, potentially for two or more separate clients. However, the Control Centre is shared to leverage specialized resources and systems, in addition to each clients' own custom documents, procedures, and operational parameters. Accordingly, the Control Centre monitors and verifies safety and regulatory standards as well as the client's operation parameters. The remote sites may each communicate with the Control Centre, and in some instances may also communicate with one or more of the other remote sites.

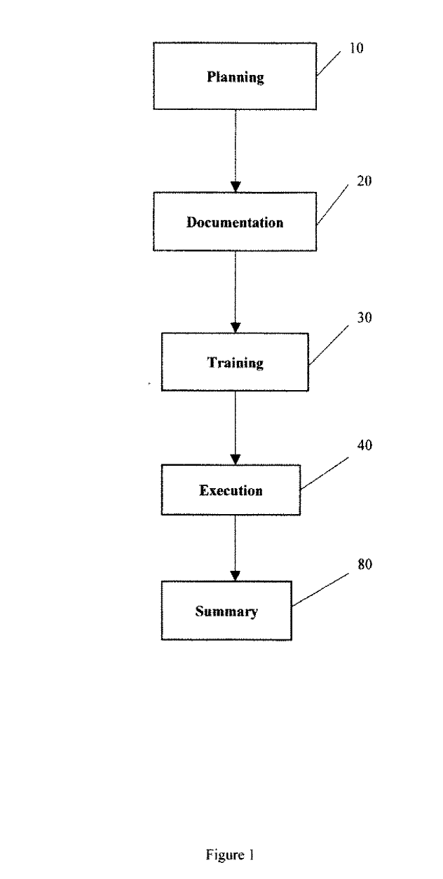

With reference to FIG. 1, a basic project flowchart is shown for use during planning and execution of remote projects. The planning module 10 is initiated to determine appropriate operational guidelines—for example timeline, location, objectives, site access, site safety, equipment and personnel requirements, and the like. The guidelines are documented 20, including the development of project-specific procedures, forms, and data entry tools for use at a work site in documenting compliance with the guidelines.

All personnel are trained 30 to become knowledgeable about the operational guidelines, and the documentation required to support the guidelines. Personnel and contractors commencing participation in the project at a later date will also be trained 30 so as to become familiar with the operational guidelines and related documentation requirements. The plan is executed 40, and all documentation is summarized 80 to determine whether compliance with project parameters has been achieved.

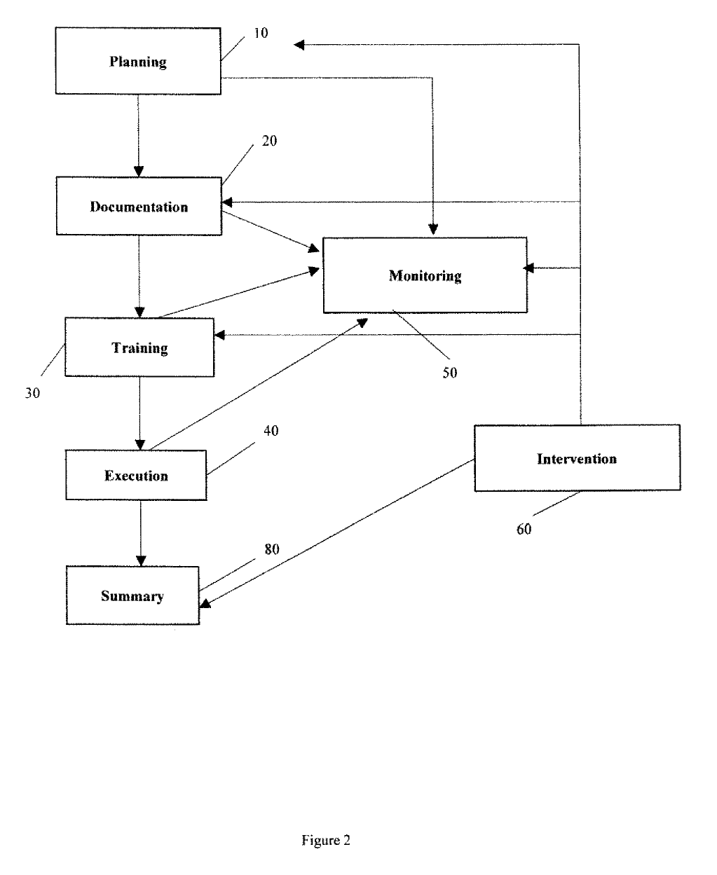

It is advantageous that any documentation or compliance problems be detected and corrected immediately, during project execution 40. Accordingly, a Monitoring Module 50 and Intervention Module 60 are incorporated into the project, as shown in FIG. 2.

The Monitoring Module receives input from Planning Module 10, Documentation Module 20, and Training Module 30. That is, the Monitoring Module 50 receives information regarding the expected operational guidelines, objectives, and documentation requirements sufficient to monitor project execution. Thus, the Monitoring Module 50 is able to flag any variance to initiate corrective action via the Intervention Module.

The Intervention Module 60 provides analysis of flagged variances reported by the Monitoring Module 50, and takes corrective action, adjusting the project plan, operational guidelines, documentation requirements, training, or execution as appropriate.

In most embodiments, operational compliance will ultimately be monitored from a central monitoring location. While some monitoring activities will take place at the remote site, all remote site monitoring data will be delivered to the central monitoring location for analysis. At the monitoring location, specialists are available to review compliance in various aspects of the operation. For example, a safety specialist and regulatory specialist may be present/accessible at the monitoring location. These specialists will be monitoring several remote sites simultaneously, such that their capacity and expertise is fully and appropriately utilized. It is the responsibility of these specialists to remain updated as to the current industry or regulatory standards associated with their specialty, for example regulations, best practices, emergency response plans, IRPs, ARPs, road use agreements, maps, surveys, provincial mapping and emergency response systems, WHMIS information, and asset logistics (including personnel, contractors, and equipment). GIS route and mapping capabilities may assist monitoring and/or verification of assets.

Implementation of the system at a remote site is expected to create a culture of operational compliance among site workers, who realize their daily compliance is being monitored around the clock by experienced specialists at the central monitoring site. Supervisors will be provided with a support network to refer to for assistance, and to offload specialized tasks. Due to the real time monitoring and analysis of operational compliance, an employer is able to react to leading indicators of operational non-compliance rather than lagging indicators based on previous errors and oversights.

### Project Planning Module 10

During planning of a remote work site, appropriate specialists are consulted to assist in the development of the operational guidelines. For example, a security consultant would suggest site security options, and an outsourcing consultant might be useful in identifying contractor selection criteria. Similarly, a safety consultant might plan safety training, certification of contractors, handling of hazardous materials, environmental safety, emergency response and first aid availability. Legal/regulatory specialists may be required, to determine legislated site requirements and approvals needed, and quality control specialists may also be useful.

The Project Planning Module would also include project management projections as to timing for various stages of planning, set-up, on-site work initiation, monitoring intervals, etc. In addition, the site conditions are determined, approvals obtained, scope of on-site work defined, standard contracts established, regulatory approvals validated, permits, design work, site surveys, road and access assessment, and safety requirements completed, etc.

For each type of contractor or individual expected on-site, standards for selection and performance are documented so contractors may be validated prior to commencing work. For example, the standard requirements may include: signed contract, scope of work document, documented achievement of safety requirements, documented qualifications, and emergency response plan.

A sample Contractor pre-screening checklist is shown below:

| Selection Criteria | Attained (Yes, No) | |
|---|---|---|
| WCB Insurance | Y | N |
| Financially Responsible/Insurance Amounts | Y | N |
| Adequate | | |
| Service and Supply Contracts (review client's | Y | N |
| EH&S expectations) | | |
| Compliance Capability Assessment | Y | N |
| Safety Statistics Suitable | Y | N |
| Supervision Skills - referral, qualifications, etc. | Y | N |
| Hazard Assessment and Mitigation Documentation | Y | N |
| Worker Competence/Training | Y | N |
| Equipment Lists, Safety Certifications, etc. | Y | N |

Risk management may be specifically or inherently contemplated within the Planning Module 10. That is, in Planning Module 10, all project risks are assessed to pre-empt undesirable occurrences, and the operational guidelines are developed to minimize these risks. Examples of risks may include worksite hazards, geographic and demographic issues such as local labor and infrastructure, community wellness, and environmental impact.

Negotiation of deliverables and payment schedules may also be established within the Planning Module 10.

### Documentation Module 20

The Documentation Module includes documentation of the details discussed in the Planning Module 10, as well as establishment of documents (physical or electronic) for completion on-site during execution of the project to facilitate collection of operational data. This data will be used to monitor work site compliance with the operational guidelines, and may be relied upon for liability purposes in the event that an unexpected event occurs at the work site, or should the project endpoints not be met.

From the operational guidelines established during the Planning Module 10, training procedures, security procedures, quality assurance protocols, contracts, and regulatory approvals can be committed to paper. Expected milestones and project performance criteria may also be documented.

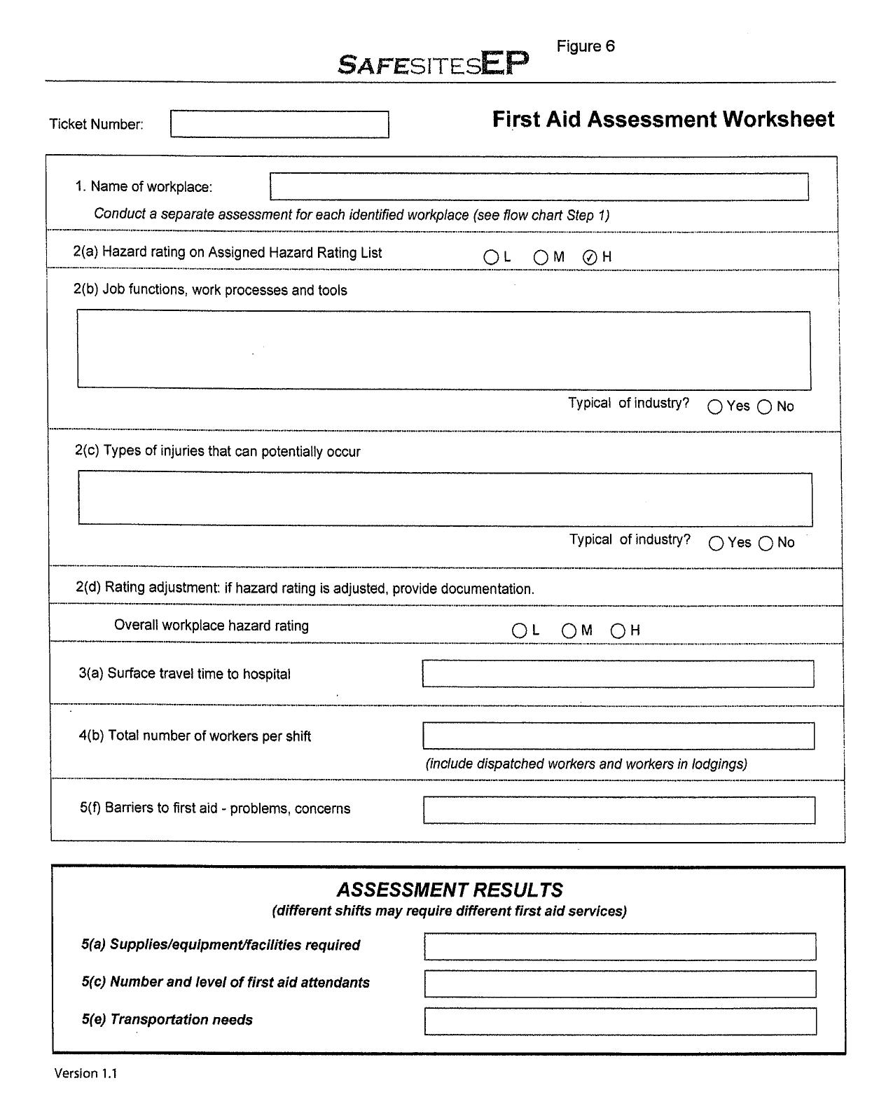

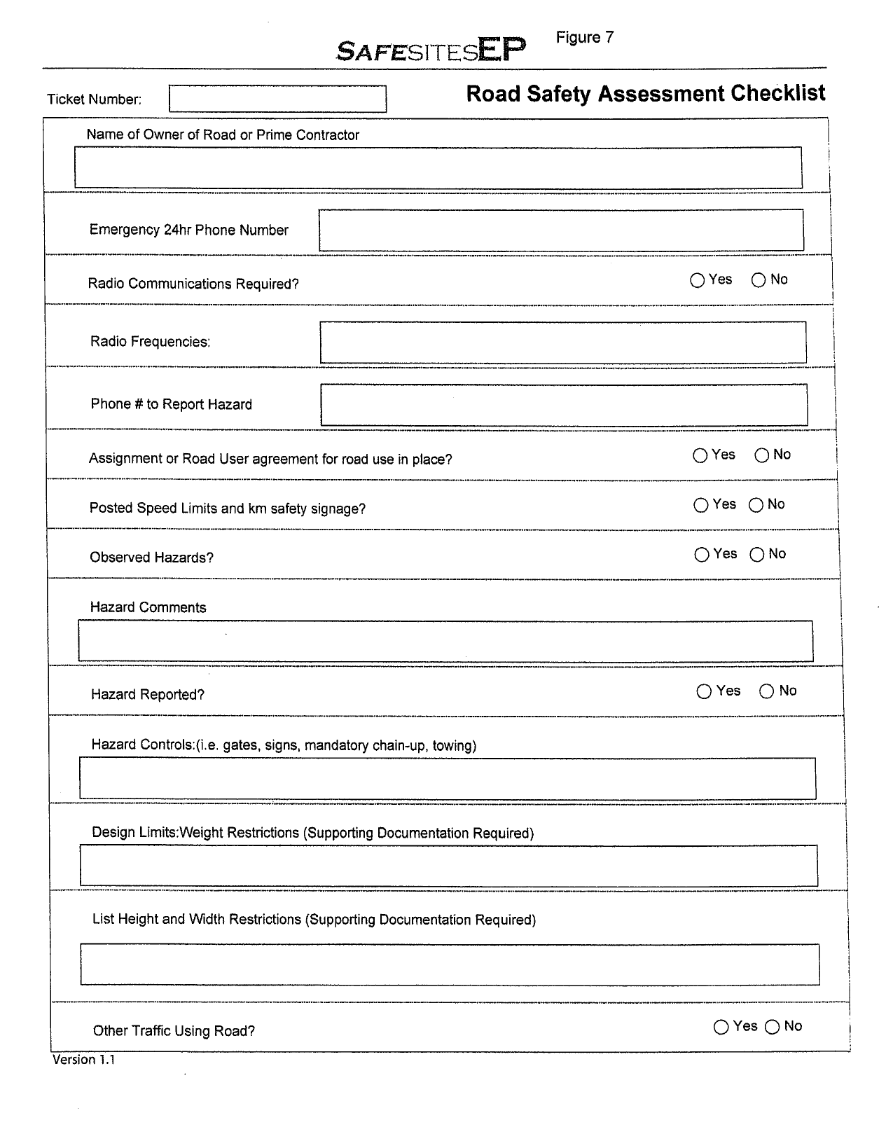

Examples of documents and forms for use on site might include:
Daily Site Work Plans (DSWP) listing all contractors, personnel and equipment on site, the security or safety protocols associated with each task to be performed, a list of operational risks and risk mitigation strategies applicable based on the individuals and equipment present, and the expected tasks to be performed that day
Safety, security, and regulatory checklists in respect of each task performed on-site
Asset location log
Maintenance records relating to Hazard identification
Tracking sheets relating to personnel/contractor attendance and man-hours
Access checklists and recordkeeping documents
Safety assessments (see example in FIG. 6) and performance records
Resource road safety monitoring records (see example in FIG. 7)

### Training Module

All individuals approved to work at a remote site must be trained in the operational guidelines associated with the specific site where work will be performed. Any additional personnel or contractors that may be required from time to time must also be trained in advance of any tasks being performed on site. All individuals and contractors should have documentation readily available to submit in respect of all tasks to be performed. For example, if electrical work may be required on site, and regulatory guidelines dictate that specific training or hazard prevention is required, a document such as a checklist should be completed upon each instance to verify that such training and preventative measures were taken.

In addition, all monitoring staff require training in the operational guidelines, possible variances from the guidelines, and corrective action that may be implemented to improve compliance with the operational guidelines.

### Monitoring Module 50

The monitoring module 50 is primarily implemented from the monitoring site. However, the Monitoring Module 50 may have many components. For example, each individual associated with a work site may be responsible for self-monitoring compliance with operational guidelines, as facilitated by daily documentation of compliance (eg. completion of daily work plan or task checklists). When an individual becomes aware of a variance from the operational guidelines, the individual may log this variance and take immediate corrective action. If appropriate corrective action is not apparent to the individual, the individual may contact the site manager or the monitoring site to document and flag the variance for corrective action.

Some types of variance from operational guidelines may only be noted at the monitoring site based on documentation and data coming from the remote work sites. For example, a site manager may complete a daily work plan indicating that Contractor A will be on site to complete Task A. Review of the daily work plan at the monitoring site may reveal that Contractor A's safety certification is not current. The monitoring operator at the monitoring site may then contact the site manager to deny site access to Contractor A until the problem is rectified by Contractor A. Should this lack of certification have been undetected on the day the work was performed, a variance report would be completed by the monitoring site, and appropriate action may be taken to minimize the risk that this will be repeated. For example, the operational guidelines may be adjusted to provide additional documentation or training.

The monitoring module may also include site audits, inspections, video surveillance, global positioning system tracking of personnel and equipment, interviews with personnel and contractors regarding conduct of the site operations, etc.

With respect to monitoring of equipment, the operational guidelines may include equipment maintenance procedures, logging in/out of equipment arriving at the site or leaving the site, sharing and transport of equipment between sites, and usage or storage of specific equipment within approved areas.

If an Intervention Module 60 is present, the Monitoring Module 50 logs all variance from site operating guidelines and flags these variances for action by the Intervention Module 60.

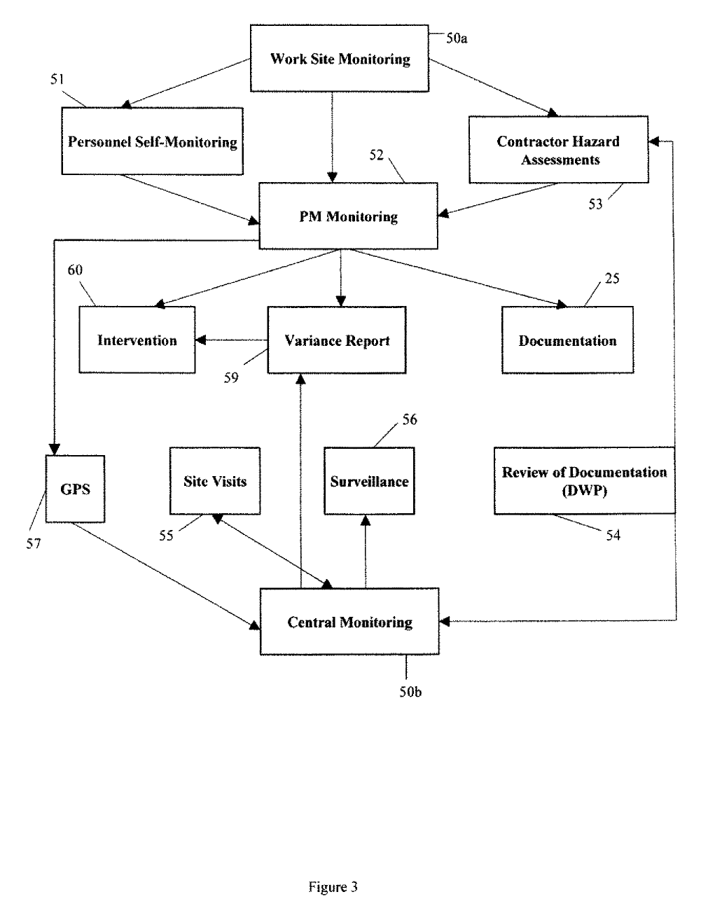

With reference to FIG. 3, the Monitoring Module 50 may include Work Site/Remote Monitoring 50a and Central Site Monitoring 50b. At the remote work site, personnel may be engaged in self-monitoring 51. That is, their training may have set a standard of conduct and operation while working at the remote site. Accordingly, a worker may be required to report any noted variances from operational guidelines to the site project manager. Similarly, the training provided to external contractors may require that hazard assessments 53 in respect of their work or equipment be conducted whenever they are on site, which may result in a variance report to the site project manager. Further, the site project manager may be required to monitor 52 site conditions and operations to verify compliance with operational guidelines. Accordingly, Work Site Monitoring 50a results in documentation 25 of operations at the remote site, and generation of a variance report 59 when necessary.

A sample Safety Assessment for use in documenting/evaluating a contractor may read as follows:

| Criteria | Rating | Comments |
|---|---|---|
| Contractor Equipment safe and maintained | 1 2 3 4 5 | |
| Contractor had documented procedures relating | 1 2 3 4 5 | |
| to the scope of work | | |
| Contractor conducted daily pre-work meetings | 1 2 3 4 5 | |
| (thorough and well attended) | | |
| Contractor conducted hazard assessments | 1 2 3 4 5 | |
| Supervision (knowledge, compliance and safety) | 1 2 3 4 5 | |
| Leadership (by example, attends safety meetings, | 1 2 3 4 5 | |
| conducts orientations) | | |
| Communication (daily, at meetings, regarding | 1 2 3 4 5 | |
| critical tasks) | | |
| Documentation and Data (thorough, effective) | 1 2 3 4 5 | |

When a contractor is introduced to the site, particularly if the contractor will be present for many days, the contractor may be made responsible for some monitoring functions. For example, if the contractor is supervising his own workers, the contractor may complete a daily work plan for submission to the site project manager or directly to Central Monitoring. The contractor may monitor compliance of his workers, or require the workers to self-monitor. If there is no change in site conditions, scope of work, or new workers, work can continue daily with minimal documentation. Alternatively, if new equipment is to be used on site, a new worker is present, or a new process or task is initiated, additional documentation may be required to ensure site compliance. Responsibility for training regarding the new scope of work, etc. may lie with the site project manager or with the contractor. These details are documented and submitted to Central Monitoring. The Contractor may be evaluated periodically by the site project manager or by Central Monitoring.

Similarly, the Monitoring Module 50 may include monitoring procedures at the central site 50b, which may be conducted centrally for all remote operational work sites. Tasks based from the central site may include constant or periodic review of daily work plans 54 submitted by each site project manager. Site visits 55 may also be conducted periodically by the central site monitoring team. Further, electronic monitoring may be accomplished by surveillance 56 or GPS-based tracking 57 of resources.

Resources tracked by the Monitoring Module 50 may include personnel, vehicles, equipment, documents, hazardous materials, data sources, and other assets. GPS-based tracking of resources provides further validation of the location and identity of the resource. Such tracking may be manual or automated, such that GPS validation data is uploaded periodically or constantly available to the Monitoring Module 50.

### Intervention Module 60

The Intervention Module may be separate from the Monitoring Module, or may be integrated therewith. For example, the Intervention Module 60 may be an added function of the Monitoring Module 50.

The Intervention Module 60, reviews all reported variances flagged by the Monitoring Module 50 and determines whether action is needed to correct the operational procedures, training, documentation, etc. to prevent recurrence of the variance. For example, the Intervention Module 60 may limit site access to a particular individual, shut down non-compliant sites, replace non-compliant equipment, and request new documents, including permits, hazard assessments, and safe work plans.

The Intervention Module prepares project variance reports for the employer to assist in the reallocation of resources or mitigation of operational risk, for example providing additional training or rehabilitation in respect of non-compliant behaviours.

The Intervention Module 60 provides project compliance reporting to other stakeholders and regulatory bodies, if appropriate.

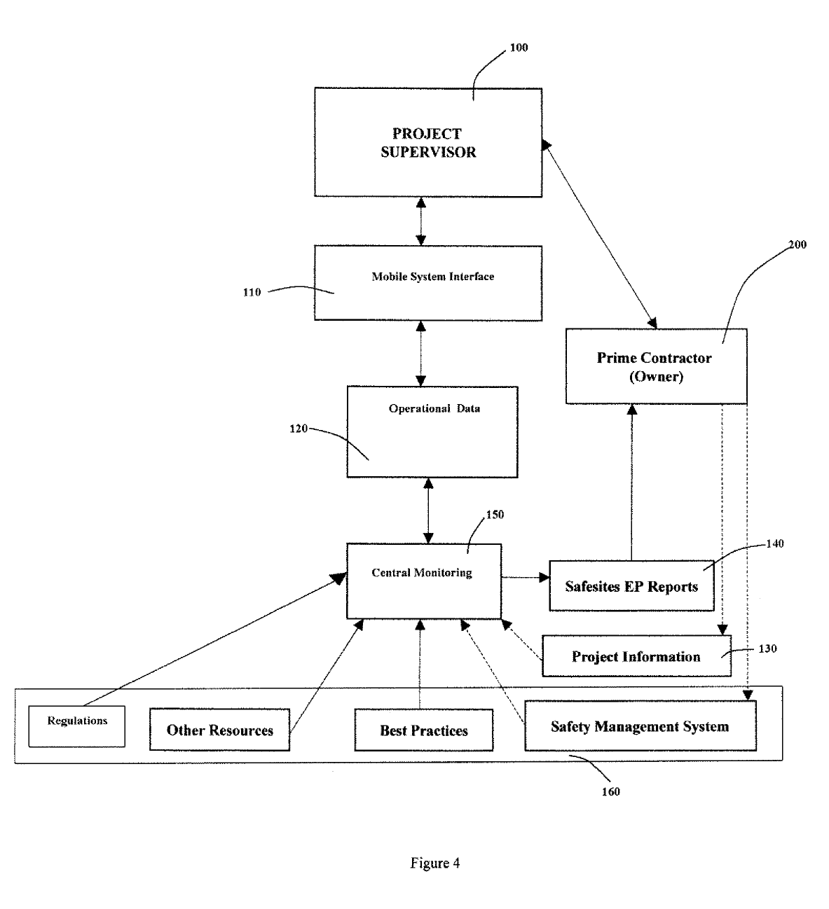

A computer-implemented documentation system is outlined in FIG. 4, in which a project supervisor 100 at a remote site electronically documents and implements a Daily Work Plan or other operational data 120, and submits same to a Control Centre 150, for example using mobile technology 110. The project supervisor monitors the remote site and the location of any equipment using GPS technology, and can submit confirmation of asset location, site compliance, variance data, follow-up action, etc. to the Control Centre. The Prime Contractor (i.e. the company responsible for the work site) 200 may also be in direct mobile contact with the project supervisor, and may have access to the Control Centre documentation 130 and reports 140. The system provides safety support for projects in which logistics and economics have previously limited detailed communication regarding work site compliance. The GPS-based data collection reduces manpower and improves the ability to verify and monitor of equipment, roads, and personnel.

An added function of the Control Centre is as a resource to on-site managers, workers, and contractors. As the Control Centre contains experienced specialists or access to specialized databases 160, for example safety and regulatory databases or specialists knowledgeable in achieving compliance, the ability to share access to such individuals and information over a number of job sites reduces direct costs in retaining specialized services, improves access to these services, and reduces barriers to site managers in seeking specific expertise regarding compliance and handling of potentially hazardous or non-compliant situations.

The Central Monitoring Location or Control Centre, has access to all of the records associated with each work site. Accordingly, when a Daily Work Plan arrives from a given remote work site, the Control Centre can ensure that the operating parameters for that work site are met, and offer any requested assistance in addressing variances or unexpected events. In addition, the Control Centre specialists have access to Best Practices standards and protocols, new legislation regarding health and safety, environmental regulations, workplace hazards, and hazardous material handling. This information may be requested by site managers as desired.

The Control Centre may further have access to GPS data showing all equipment, vehicles, contractors, and workers, and may therefore verify to some extent the man-hours and conditions recorded on the remote site. Further, should any worker require emergency assistance, help may be dispatched precisely to the required location. Any transfers of equipment between remote sites may similarly be monitored, and road conditions may be updated in real time by mobile workers.

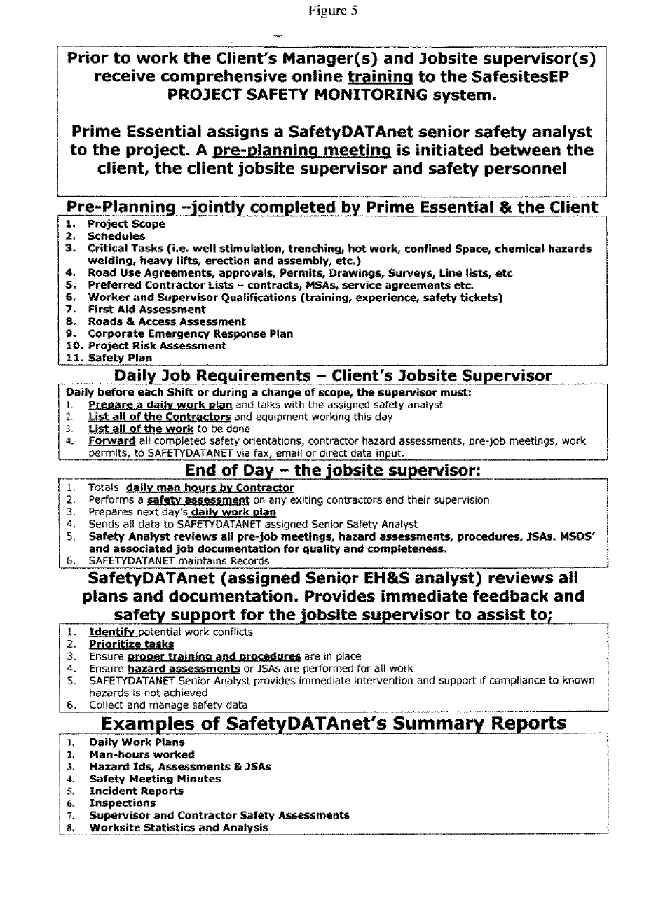

An example outline of planning, tasks, communications, and reporting, is shown in FIG. 5. A sample First Aid Assessment and Road Safety Assessment are shown in FIGS. 6 and 7, which may be completed manually, or on a computer or mobile device and then submitted to the Control Centre.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for monitoring operational compliance at multiple work sites from a central monitoring site, the system comprising:
a planning module for setting operational guidelines for first and second work sites;
a documentation module for daily recordal of operational data at said first and second work sites;
a monitoring module for receiving recorded data from each work site, comparing said data to the respective operational guidelines, and initiating corrective action in respect of any variance between the received data and the operational guidelines.

2. The system as in claim 1 wherein the operational data is recorded electronically, and wherein the monitoring module comprises a processor programmed to compare the recorded data from each work site to the operational guidelines.

3. The system as in claim 1, wherein the corrective action comprises revising one or more operational guidelines.

4. The system as in claim 1, wherein the corrective action comprises setting additional operational guidelines.

5. A system for use in monitoring activity at two or more remote sites, the system comprising:
a data input device at a first project site, the input device for use in entering operational data documenting activities at the first project site;
a data input device at a second project site, the input device for use in entering operational data documenting activities at the second project site; and
a central monitoring location comprising a processor in communication with the input devices, the processor comprising a set of project site operational guidelines for use in assessing compliance of the activities at the first and second project sites.

6. The system as in claim 5, wherein the processor compares the operational data to the operational guidelines to determine the presence of a variance event.

7. The system as in claim 6, further comprising an alert module for initiating an alert at the central monitoring location, first project site, or second project site when a variance event is detected.

8. The system as in claim 5, wherein the operational data comprises GPS validation data of project resources.

9. The system as in claim 5, wherein the operational data comprises equipment maintenance data.

10. The system as in claim 5, wherein the operational data comprises training verification data or certification data.

11. The system as in claim 5, wherein the operational data comprises personnel or contractor performance data.

12. The system as in claim 5, wherein the operational data comprises surveillance data.

13. The system as in claim 5, wherein the operational data comprises daily work plan verification.

14. The system as in claim 5, wherein the operational data comprises site access data.

15. The system as in claim 5, wherein the operational data comprises variance data.

16. The system as in claim 5, wherein the operational data comprises safety compliance data.

17. The system as in claim 5, wherein the operational data comprises incident report data.

18. The system as in claim 5, wherein the operational data comprises regulatory compliance data.

19. The system as in claim 5, wherein the operational data comprises attendance data.

20. The system as in claim 5, wherein the operational data comprises inspection data.

21. The system as in claim 5, wherein the operational data comprises safety status data.

22. A system for monitoring operational compliance at multiple work sites from a monitoring site, the system comprising:
a first set of operational guidelines associated with a first remote work site;
a first operator located at the first remote work site for supervising and documenting operations at the first work site in accordance with the first set of operational guidelines;
a second set of operational guidelines associates with a second remote work site;
a second operator located at the second remote work site for supervising and documenting operations at the second work site in accordance with the second set of operational guidelines;
a compliance management module in communication with the first and second operators for receiving and reviewing documents of daily operations from the first and second operators, comparing said documents to the first and second operational guidelines, and initiating communication with the first and second operators regarding the correction of any variance between the documents and the operational guidelines.

23. The system as in claim 22, wherein the compliance management module accesses relevant standards and/or regulations and updates the first and second operational guidelines accordingly.
